(19) United States
(12) Patent Application Publication
(10) Pub. No.: US 2009/0146544 A1
(43) Pub. Date: Jun. 11, 2009

(54) Discharge Lamp for Dielectrically Impeded Discharges with a Botton Plate and a Cover Plate and Supporting Element Therebetween

(75) Inventor: Hans-Gerhard Burzele, Herbrechtingen (DE)

Correspondence Address: OSRAM SYLVANIA INC, 100 ENDICOTT STREET, DANVERS, MA, 01923, US

(73) Assignee: Patent -Treuhand-Gesellschaft Fur Elektrische Gluhlampen MBH, Munchen (DE)

(21) Appl. No.: 11/992,481

(22) PCT Filed: Sep. 25, 2006
(86) PCT No.: PCT/EP2006/066705

§ 371 Date: Mar. 24, 2008

(30) Foreign Application Priority Data
Sep. 28, 2005 (DE) 10 2005 046 481.5

(51) Int. Cl. H01J 1/62

(52) U.S. Cl. 313/484

(57) ABSTRACT

Discharge lamp for dielectrically impeded discharges with a bottom plate and a cover plate and supporting elements therebetween the invention relates to a discharge lamp for dielectrically impeded discharges having a flat lamp design. In this case, supporting elements (5) are provided between a cover plate (1) and a bottom plate (2), and each comprise two supporting projections (5a, 5b), of which one is integral with the cover plate and the other is integral with the bottom plate.

### TECHNICAL FIELD

The present application relates to discharge lamps for dielectrically impeded discharges with a flat design having a bottom plate and a cover plate.

### PRIOR ART

Discharge lamps which are designed for dielectrically impeded discharges and which consequently have a dielectric between at least part of the set of electrodes and the discharge medium have long been known.

A technically attractive design involves so-called flat radiators, i.e. lamps with a flat design for example for backlighting monitors or else for interior lighting. Such flat radiators have a discharge vessel, which has a bottom plate and a cover plate connected thereto, at least one of the plates being partially transparent and in this case being referred to as the cover plate for reasons of simplicity. In some cases, these plates are connected by a separate frame, and in other cases the frame is an integrated component part of one of the plates. The plates enclose between them, possibly together with the frame, a discharge space with the discharge medium.

It has also long been known to provide supporting elements in the discharge space which support the cover plate and the bottom plate with respect to one another. The mechanical strength of the discharge vessel can thereby be ensured or improved, in particular the flexural strength of the plates. In addition, thinner plates can be used as a result, which is advantageous for various reasons, and in the case of outer electrodes also for electrical reasons.

There is often also the need for supporting elements as a result of the discharge medium having a lower pressure than the outer atmosphere and of a corresponding loading of the discharge vessel, primarily also in the case of larger formats of the flat radiators, for example for large-format display screens.

Finally, it is known to configure these supporting elements as an integrated component part of the bottom plate or the cover plate and therefore to avoid the necessity for fitting separate supporting elements. In this context, it has also been proposed to configure the supporting elements in such a way that they bring with them advantageous optical effects for the homogenization of the light emission. Overall, reference is made to the following documents: DE10048187, DE10048186, DE10138924, DE10138925.

This prior art also assists in the understanding of the invention as illustrated below and shows various features and aspects which may also be of advantage in combination with the invention as illustrated in the text which follows.

### DESCRIPTION OF THE INVENTION

The present invention is based on the technical problem of specifying an improved discharge lamp of the described type which demonstrates advantages as regards the supporting of the bottom plate and the cover plate with respect to one another.

The invention in this case relates to a discharge lamp of the described type, in which at least one supporting element is provided which has two supporting projections, which are each formed as an integral component part of the bottom plate or the cover plate.

Furthermore, the invention also relates to a display device which has been equipped with such a lamp and to a correspondingly equipped luminaire.

Preferred configurations of the invention are specified in the dependent claims and will be explained in more detail in the text which follows.

The basic concept of the invention consists in designing the supporting elements from in each case two supporting projections, of which in each case one is an integrated component part of the bottom plate or the cover plate. In the prior art, it has been assumed that, in particular for reasons of homogenization of shadowing produced on a contact face between the supporting element and the bottom plate which is as complete as possible, it is expedient to arrange the contact face as far away as possible from the light exit face.

The inventor of the present invention has made the observation, however, that problems can result when forming the supporting elements with a specific required height as a component part of only one of the plates, in particular the cover plate. In the case of deep-drawn cover plates and cover plates which are formed with supporting projections as a plate profile, these problems consist in the fact that the manufacturing tolerances increase severely as the height of the profile increases. It is then more difficult to actually precisely achieve the desired height with the supporting projection(s) and possibly complex post-treatment processes are required, for example more significant subsequent heating in order to match the levels. Other manufacturing processes can also display disadvantages which correlate with the height of the supporting projections.

In addition, the supporting projections are often shaped out of the respective plate. In this case, it may occur that the wall thickness of the supporting projections decreases as the height increases and, for example, in the case of glass plates, problems associated with stability and stresses occur. This can result, primarily during cooling in stresses caused by the different wall thicknesses and these stresses being incorporated in the cooled plate. These problems are also dependent on the height of the supporting projections, with the result that the distribution of the required overall height of the supporting elements over two supporting projections may be advantageous.

In addition, the invention also provides the possibility of designing the bottom plate and the cover plate to be largely or entirely identical and therefore of introducing increased standardization into the lamp manufacture. However, this is one option and is not an essential feature of the invention.

Finally, plates which have been equipped with supporting projections can be formed to be more mechanically stable per se than flat plates, with the result that advantages associated with stability can also be brought about by equipping both the bottom plate and the cover plate with integrated supporting projections.

As in the prior art as well, in the context of the invention preferably a large number of supporting elements and correspondingly a large number of supporting projections are provided and distributed largely uniformly over the discharge space. The free bending lengths between adjacent supporting elements should therefore not be too great. In addition, if the optical properties of the supporting projections at least of the cover plate are also taken into consideration, for this reason large numbers of supporting projections may be advantageous.

Preferably, the cover plate and the bottom plate are already manufactured with these projections using a suitable shaping process, for example deep-drawn or pressed. However, the projections can also be attached subsequently. However, it is essential that the cover plates have supporting projections which are formed integrally with it during the fitting of the lamp.

The supporting projections should, at least on the side of the cover plate, advantageously consist of transparent material in order to be able to utilize such optical properties. In this case, the supporting elements can also be completely or partially coated with a phosphor. However, supporting projections can also have an advantageous concomitant effect with the light distribution when they are not transparent, for example because they are provided with reflective layers.

Preferably, the supporting projections and also the bottom and the cover plate consist of glass.

In one configuration of the invention, the shaping of the supporting projections on the side of the cover plate is designed in such a way that cross-sectional planes result at right angles with respect to the cover plate with a tapering cross section and in this case there is no cross-sectional plane, in which the supporting projection is considerably widened in the direction towards the bottom plate. In other words, this means that the outer face of the supporting projections on the side of the cover plate faces the discharge space of the bottom plate, in any case the substantial part of the outer face. There may also be individual regions of the outer face which run at right angles with respect to the bottom plate, but not over a substantial part of the circumference of the supporting projections. In this case, the outer face extends from that end of the supporting projection which is on the side of the bottom plate as far as the cover plate, i.e. in this case it is not a question of a small subregion of the outer face.

That is to say that if the supporting projections according to the invention on the side of the cover plate are delimited by the described outer faces which run at an angle, as a result of the refraction of light which is incident from the discharge space or as a result of corresponding alignment of the emission characteristic of a phosphor layer on the outer face, they ensure alignment of light in the core region of the supporting projections. It is therefore possible to counteract the shadowing produced as a result of the contact with the supporting projection on the side of the bottom plate.

In addition, together with a pattern of individual discharges, which pattern is predetermined by the electrode structure, in an overall configuration of the supporting projection arrangement and the discharge structure, optimization to achieve a luminance which is as homogeneous as possible can be carried out. In addition to the shadowing effect of the contact between the supporting projections, it should also be taken into consideration that the individual discharge structures typically do not burn below but between supporting projections. The maxima of the UV production therefore likewise lie between the supporting projections. As a result of the optical deflection effect, the light can be brought partially from these regions into the regions of the supporting projections, with the result that a relatively homogeneous luminance is provided on the upper side of the cover plate. The basic concept of the invention at this point therefore, as in some of the prior art, consists in the supporting projections not being considered as impeding factors in the luminance which is to be homogenized separately of the discharge structure. Instead, the supporting projections in the invention preferably assume an active role in the light distribution and are taken into consideration to the same extent in the overall design as the discharge distribution, which is likewise inhomogeneous per se.

Where this application mentions individual discharges or discharge structures, these statements, when taken precisely, relate to regions which are predetermined by the configuration of the lamp, in particular the electrodes and the supporting projections, in which regions those individual discharge structures can burn. Depending on the operating state of the lamp, however, discharge structures with different extents are in this case also conceivable within these regions. The regions therefore do not necessarily need to be completely filled with a discharge structure. Primarily, it may be desirable in the context with dimming functions of the lamp to influence the size of the discharge structures. The details in this application therefore relate to the regions which can be filled to a maximum extent by discharge structures. If electrode structures are provided for fixing preferred positions of the discharges, a 1:1 correspondence with the discharge regions will generally be true.

Very generally, the supporting projections, even in the case of slightly larger bearing faces for the bottom plate, can run substantially in the form of ribs along the cover plate and the bottom plate or be delimited to small regions in comparison with dimensions of the plates. In the firstmentioned case, the narrow contact faces generally involve linear contact faces, and in the second case these contact faces are to do with approximately punctiform contact faces. The rib-like supporting projections can have specific stabilization functions, for example the plates are provided with improved flexural strength in one direction. In addition, as is yet to be explained in more detail in the exemplary embodiments, they can also serve the purpose of separating specific regions in the discharge space slightly from one another in order to influence the discharge distribution. In this context, of particular interest are supporting projections which meander around individual discharge locations in the discharge space and which are yet to be illustrated in the exemplary embodiments. They can therefore, together with the electrode structure, define preferred locations for individual discharges and separate individual discharges from one another along identical electrodes. On the other hand, the supporting projections which are locally delimited in two directions of the plate plane provide the possibility of minimized shadow effects and are generally sufficient for the supporting function.

A preferred form for locally delimited supporting projections can therefore be formed by a cone, a truncated cone or by a pyramid or a truncated pyramid, in the case of which the (truncated) point faces the respectively opposite plate. In principle, any desired basic forms are possible, i.e. any desired faces delimited by curves, polygon faces or mixtures thereof. However, largely edge-free supporting projections, i.e. cones and truncated cones, are preferred because the edges can result in certain irregularities in the light distribution.

A further aspect of the invention which is novel over the cited prior art consists in using supporting projections with an asymmetrical form. The asymmetry in this case relates to mirror planes, which are at right angles with respect to the respective plates and at right angles with respect to a respective adjacent discharge. If it is assumed that the discharges run in the sense of their direction of flow approximately parallel to the plates and moreover display an average flow direction, therefore one mirror plane (which can naturally be displaced parallel) is defined. In the case of the straight, strip-shaped electrodes which are often come across, such a mirror plane would therefore run parallel to the strip direction. A preferred form for this asymmetry are at least approximately triangular contours in section parallel to the plates. Forms for the supporting projections can therefore be found which stabilize the discharges by them preventing undesirable arcing-back to electrodes to which no discharges are desired by means of a shielding effect or at least diminishing their probability or frequency. For example, such a triangular shape can shield an electrode from another electrode to which no discharges are desired, and on the other hand limbs of such a triangular form can leave discharge locations free into which the desired discharges can easily pass. For illustrative purposes, reference is made to the exemplary embodiments.

In particular, individual discharge locations can be delimited by this means by supporting elements which, as a result of this delimiting, are narrower on the cathode side than on the anode side. This therefore relates to lamps which are designed for unipolar operation and can be achieved in particular with the described asymmetric supporting projection forms. Such individual discharge locations which are narrower on the cathode side can, however, also be achieved in individual cases with supporting projections which are symmetrical in the above sense. Moreover, the explanations apply not only to “individual” supporting projections, i.e. for example cones or pyramids, but also to rib-shaped constructions.

A preferred arrangement for the individual discharge locations along strip-shaped electrodes provides that the individual discharge locations are separated in each case by a supporting element on one side of an electrode strip.

In addition or as an alternative to the creation, as known per se, of preferred locations for individual discharges, for example by means of tab-like projections, the individual discharge locations can therefore be determined by the free spaces between the supporting elements. In connection with this invention, moreover, the individual discharges are not only understood to mean the trapezoidal or triangular individual discharges which have already been described a plurality of times in the prior art and which attach to, for example, an individual cathode “tab”, but also widespread “curtain-like” structures.

Preferred applications of the invention, as has already been mentioned, lie in the field of backlighting of display devices such as monitors and display screens, but also in the field of general lighting and interior lighting. Accordingly, the invention also relates to a display device and a luminaire, which are each equipped with a discharge lamp according to the invention.

### BRIEF DESCRIPTION OF THE DRAWINGS

The invention will be explained in more detail below with reference to exemplary embodiments, it being possible for the disclosed features to also be essential to the invention in other combinations.

FIG. 1 shows a sectional view through a discharge lamp according to the invention as a first exemplary embodiment.

FIG. 2 shows a detail from FIG. 1.

FIG. 3 shows a plan view of the electrode structure and supporting projection structure of the first exemplary embodiment.

FIG. 4 shows a plan view of a detail of an electrode structure and supporting projection structure of a second exemplary embodiment.

FIG. 5 shows a detail and section view relating to the second exemplary embodiment from FIG. 4.

FIG. 6 shows an illustration as in FIG. 5 relating to a variant of the second exemplary embodiment.

FIG. 7 shows a plan view of a detail of an electrode structure and supporting projection structure of a third exemplary embodiment.

FIG. 8 shows a detail and section view relating to the second exemplary embodiment from FIG. 5.

FIG. 9 shows an illustration as in FIG. 6 relating to a variant of the second exemplary embodiment.

FIG. 10 largely corresponds to FIG. 3 and relates to a third exemplary embodiment.

### PREFERRED EMBODIMENT OF THE INVENTION

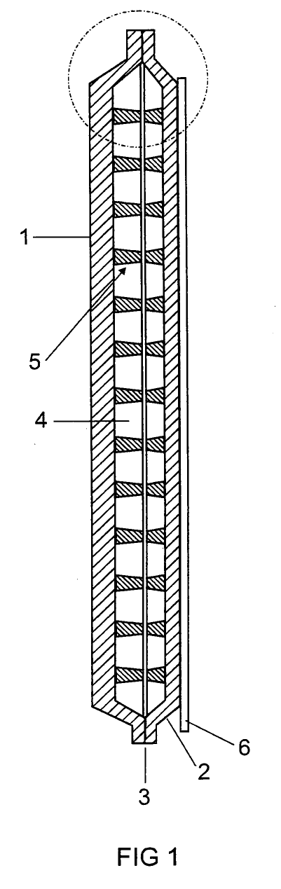

FIG. 1 shows a section view through a discharge lamp according to the invention with a design in the form of a flat radiator. A cover plate 1 and a bottom plate 2 rest one on top of the other in an edge region 3 and enclose a discharge space 4 between them. The plate planes are at right angles with respect to the plane of the drawing, the section line in the plane of the drawing being vertical.

The cover plate 1 and the bottom plate 2 are each arched slightly towards the edge region 3, with the result that they can come into contact with one another in the edge region 3 and nevertheless a cavity 4 exists between them. The corresponding arching of the cover plate 1 in this exemplary embodiment is slightly more pronounced than that of the bottom plate 2.

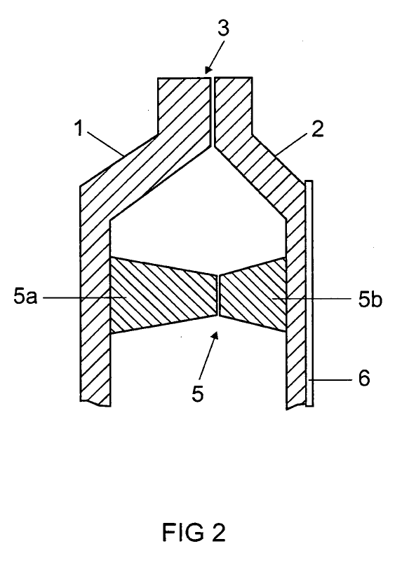

FIG. 1 already shows that the cover plate 1 and the bottom plate 2 are supported with respect to one another via supporting elements 5, which are configured in two parts. The circle illustrated by dashed lines in the upper region of FIG. 1 in this case refers to the detail illustrated in FIG. 2. In the region of the transition between the two parts of the supporting elements, namely the supporting projections 5a and 5b, two vertical lines are illustrated in FIG. 1 which symbolize the transition, which lies behind the supporting elements between the cover plate 1 and the bottom plate 2 in the edge region 3 and are omitted in FIG. 2.

FIGS. 1 and 2 finally show that, in the first exemplary embodiment, an electrode system in the form of an outer printed circuit board 6 is provided which is applied to the bottom plate 2 easily from the outside.

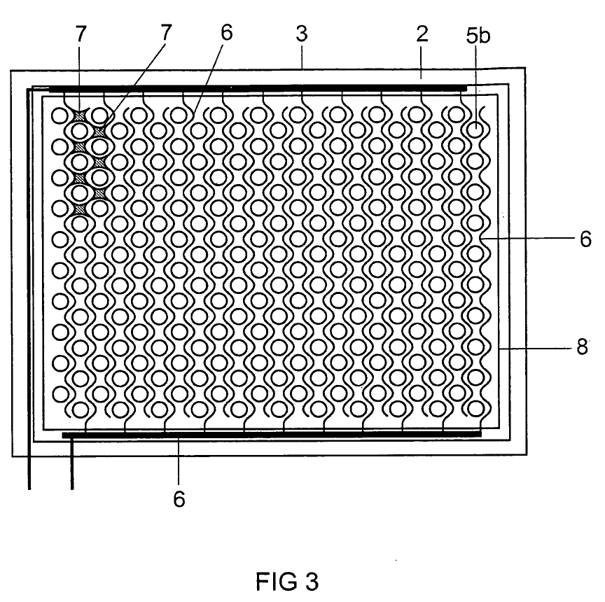

FIG. 3 shows a plan view of the bottom plate 2 from FIGS. 1 and 2 together with the electrode structure of the printed circuit board 6 lying therebeneath. By way of summary, the electrode structure is denoted by 6 and has electrodes, which are in the form of two mutually interlocking “combs”, meander sinusoidally in the plane of the printed circuit board 6 and overall, and to be precise in each case one “comb” for itself, are supplied to central connections in the lower left-hand region. The sinusoidal forms of the individual electrode strip tracks produce a modulated spacing between them, which is provided for the formation of individual discharge structures 7 in the region of the shorter spacings, as is illustrated in the upper left-hand corner in FIG. 3. These individual discharge structures are in this case illustrated in a form which results approximately if the electrode system 6 is operated in bipolar fashion, i.e. the cathode and the anode roller alternate. The illustrated form in this case to a certain extent forms the overlapping of two discharge structures, which form mirror images with respect to one another and are each constricted slightly towards the instantaneous cathode side. In relation to the geometric structure of the electrodes 6, reference is moreover made to the prior art: DE 198 44 721.

In this case, the discharges 7 burn in the discharge space 4, with the result that the electrodes 6 are separated from the discharges by the bottom plate 2 as the dielectric barrier. These discharges are therefore dielectrically impeded discharges. In this case, the discharge space 4 is delimited by the edge region 3 of the plates 1 and 2, i.e. in FIG. 3 it lies within the rectangular line denoted by 8.

The first exemplary embodiment in FIGS. 1, 2 and 3 therefore overall shows a flat radiator which is designed for dielectrically impeded discharges with a discharge vessel comprising two plates 1 and 2, these plates being supported with respect to one another by (cf. FIG. 3) supporting elements 5 which are distributed (in this case in a hexagonal structure) uniformly over the discharge space 4. The supporting elements comprise two parts and each comprise two supporting projections 5a and 5b. The supporting projection 5a is an integral component part of the cover plate 1 and the supporting projection 5b is an integral component part of the bottom plate 2. In this exemplary embodiment, the supporting projections are in the form of truncated cones which are circular (cf. FIG. 3) in the base face and have been shaped out of the plates 1 and 2 by means of deep drawing once said plates have been manufactured.

The two supporting projections 5a and 5b are directed towards one another with their truncated points and are thereby supported against one another. The cone form has the advantage that the lateral faces, which correspondingly face the respective opposite plate, of the supporting projections are therefore more favorable for the light distribution. The supporting projections 5b, when the lamp is finished, are coated with a reflective layer and, as a result of the fact that the lateral face points towards the cover plate 1, therefore have a tendency to reflect into the discharge space 4 or towards the cover plate 1. The supporting projections 5a in turn are only coated with phosphor and, in the same way as the cover plates (and the supporting projections 5b), are made of glass, i.e. are transparent. They can therefore align the light produced by the phosphor layer to a greater extent into the light exit direction, which is oriented towards the left in FIGS. 1 and 2. Moreover, the form of the supporting projections 5a and 5b is in this case only illustrated symbolically and can be varied in the course of an optimization of the geometry to a maximum luminous efficiency.

It can further be seen that the geometric structure of the electrode system 6 is matched to the distribution of the supporting elements 5 in such a way that in each case one alternating row of supporting elements 5 and individual discharge locations 7 is provided between two electrode strips. The individual discharge locations 7 are therefore each separated from one another by supporting elements 5.

A lamp of the type illustrated in FIGS. 1, 2 and 3 can be manufactured with a relatively small thickness (FIG. 1 is in this case not to scale, but emphasizes, for reasons of clarity, the thickness) in very large-area formats. Very large-format display devices can therefore also be backlit in a manner which is homogeneous, simple, comparatively easy and permanent. Moreover, such lamps open up new design possibilities for general and interior lighting, i.e. can be used, for example, in flat and horizontally extended ceiling-mounted luminaires, wall-mounted luminaires or suspended luminaires.

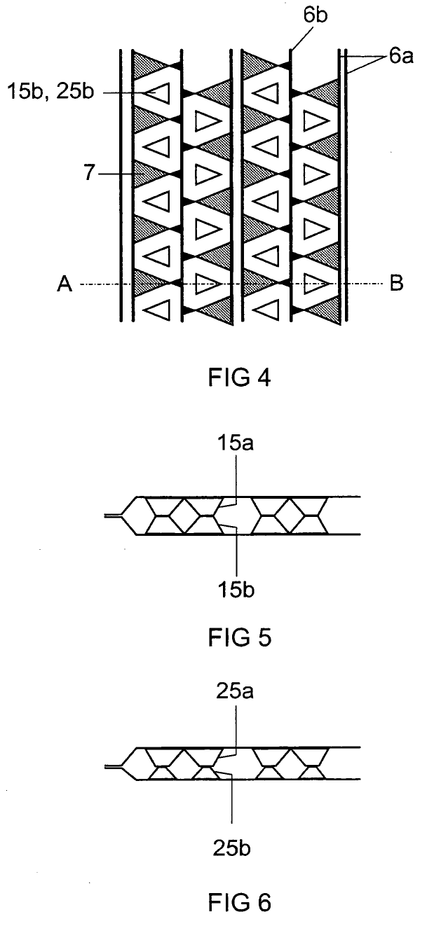

FIGS. 4 and 5 show a second exemplary embodiment in each case only in detail, it being possible to compare FIG. 4 to FIG. 3 and FIG. 5 to FIG. 2, although rotated through 90 degrees. In this case, electrodes 6 are designed for unipolar operation, to be precise with double anodes 6a and cathodes 6b as known per se which have, along their strip length and alternately on both sides, projections in the form of triangular tabs for the purpose of localizing individual discharge structures 7. Reference is made to the prior art WO 98/43276. The supporting elements are in this case denoted by 15 and have a structure which is triangular in section parallel to the plate planes. In this case, the triangles are aligned in such a way that a side edge runs parallel to a cathode strip 6b and is aligned there towards a “tab”, which is aligned towards the respective opposite side. The triangle point opposite this triangle side faces the next anode 6a. As can be seen in FIG. 4, asymmetric individual discharge locations for the discharge structures 7 therefore result, to be precise in the region of the cathodes, and the tab-like projections are constricted there to a greater extent by the supporting element 15 than in the region of the anodes.

FIG. 5 shows a section view through FIG. 4 along the line A-B corresponding to FIGS. 1 and 2, in accordance with which the supporting elements 15 are in turn constructed from a supporting projection 15a on the side of the cover plate and a supporting projection 15b on the side of the bottom plate. The form is therefore in each case truncated pyramids with a triangular base face and also a triangular frustum at the mutually facing points. As regards the inclination of the lateral faces of the supporting projections 15a and 15b in each case with respect to the opposite plate and also as regards the rest of the design, the explanations relating to the first exemplary embodiment apply. However, in this case the cover plate and the bottom plate are designed to be identical to one another, i.e. the supporting projections 15a and 15b have the same height. This has production advantages.

FIG. 6 shows a variant of FIG. 5, with slightly higher supporting projections 25a on the side of the cover plate and slightly lower supporting projections 25b on the side of the bottom plate, i.e. corresponding to FIG. 2. Such embodiments have the advantage of emphasizing the optical effects of the supporting projections 5a and 25a on the cover plate side. On the other hand, the supporting projections should in each case preferably make up at least 10%, better at least 15% and even better at least 20% of the spacing between the plates which is bridged by the two supporting projections together, i.e. the supporting element.

Moreover, the supporting projections 15a, 15b and 25a, 25b in this second exemplary embodiment as well are deep-drawn in both variants together with the plates in one manufacturing step; the truncated pyramids are therefore to a certain extent hollow. However, the invention also relates to supporting projections which are attached subsequently, for example fused on.

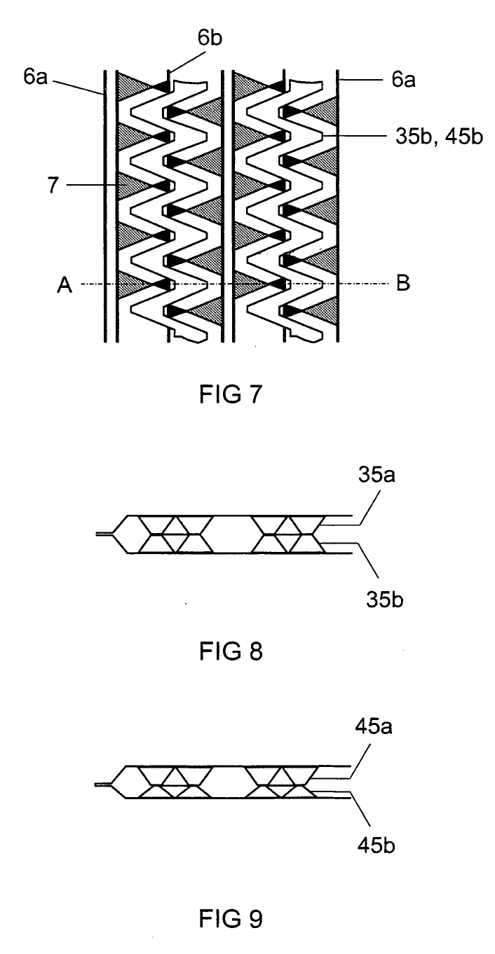

FIGS. 7 to 9 show a third exemplary embodiment, with FIGS. 7 to 9 corresponding to FIGS. 4 to 6 in each case in this sequence. In particular, FIGS. 8 and 9 show two variants with the same difference as that between FIGS. 5 and 6.

The main difference between the third exemplary embodiment in FIGS. 7 to 9 and the second exemplary embodiment in FIGS. 4 to 6 consists in the fact that the truncated pyramid-like supporting projections, which are individual in the case of the second exemplary embodiment, are in this case “fused” to provide a meandering form, i.e. rib-like supporting projections are provided. These are accordingly denoted by 35a, 35b and 45a, 45b. The rib-like supporting projections meander around the cathode 6b and between the individual discharge locations 7. In a similar manner to as in the second exemplary embodiment, in this case individual discharge locations 7 are delimited which are narrower on the cathode side than on the anode side. Instead of the triangular cross-sectional forms from FIG. 4, in this case trapezoidal sections of the rib-like supporting projections occur, the trapezoids in each case merging with one another in part of their base.

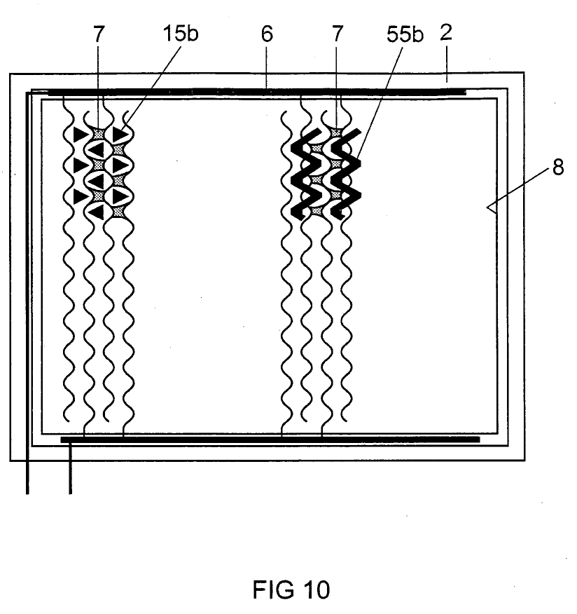

A fourth exemplary embodiment is shown in FIG. 10, which is comparable in terms of its illustration to FIG. 3, but only shows part of the electrode structure 6. The two illustrated regions form two variants. In the variant on the left-hand side, in a comparable manner to as in FIG. 4, triangular supporting projections are illustrated in cross section, which supporting projections are denoted by 15b as a result of their identical geometric formation. However, in this case they are combined with sinusoidal electrode strips as shown in FIG. 3, the discharge structures 7 illustrated being comparable with FIGS. 4 and 7, i.e. representing a unipolar operation. The explanations relating to FIGS. 4 to 6 apply.

In the region on the right-hand side of FIG. 10, a variant is illustrated in which, in a similar way to FIG. 7, rib-shaped supporting projections are illustrated, in this case denoted by 55b. The rib structures are narrower than in FIG. 7 and meander in the same way around the in this case sinusoidal electrode strips and between the individual discharge structures 7. These rib structures in turn correspond to unipolar operation, i.e. FIG. 4 and the left-hand illustration in FIG. 10. As a result of the narrower formation of the ribs 55b, in this case an even more pronounced zig-zag pattern is produced than in FIG. 7.

Overall, the asymmetric supporting projections from FIGS. 4 to 10 make it possible to optimize the shielding of the electrode tracks, where desired, with suitable formation of locations for individual discharges and at the same time utilizing the supporting projections for the light distribution by means of reflection, refraction and diffusion. The supporting projections can also stabilize the plates and, in particular in the deep-drawn variant from FIGS. 4 to 10, can be produced in a particularly simple manner with a low overall weight of the resulting plates.

1. A discharge lamp with a bottom plate (2), an at least partially transparent cover plate (1), which is connected to the bottom plate (2) in such a way that a discharge space (4) for accommodating a discharge medium is formed between the bottom plate (2) and the cover plate (1), a set of electrodes (6) for producing dielectrically impeded discharges (7) in the discharge medium, at least part of the set of electrodes (6) being separated from the discharge medium by a dielectric (2), and a supporting element (5, 15, 25, 35, 45, 55), which supports the cover plate (1) and the bottom plate (2) in the discharge space (4) with respect to one another, characterized in that the supporting element (5, 15, 25, 35, 45, 55) has two supporting projections (5a, 5b, . . . 55b), which are each formed as an integral component part of the bottom plate (2) or the cover plate (1).

2. The discharge lamp as claimed in claim 1, in which a large number of supporting projections (5a, 5b, . . . 55b) are provided which are distributed uniformly over the discharge space (4).

3. The discharge lamp as claimed in claim 1, in which the supporting projection (5a, 15a . . . ) on the cover plate side consists substantially from a transparent material.

4. The discharge lamp as claimed in claim 1, in which the supporting projection (5a, 15a . . . ) on the cover plate side, towards the discharge space (4), has an outer face, which extends from the cover plate (1) as far as the supporting projection (5b, 15b . . . ) on the bottom plate side at least substantially continuously in such a way that it faces the bottom plate (2).

5. The discharge lamp as claimed in claim 1, in which the supporting projections (35a-55b) run in the form of ribs along the plates (1, 2).

6. The discharge lamp as claimed in claim 5, in which the supporting projections (35a-55b), which run in the form of ribs, meander around individual discharge locations (7) in the discharge space (4).

7. The discharge lamp as claimed in claim 1, in which the supporting projections (5a-25b) have substantially the form of cones, pyramids, truncated cones or truncated pyramids with the respective base faces which face the plates.

8. The discharge lamp as claimed in claim 7, in which the supporting projections (15a-25b) have a form which is asymmetrical with respect to a mirror plane, which mirror plane is at right angles with respect to the plates (1, 2) and is at right angles with a respective adjacent discharge (7).

9. The discharge lamp as claimed in claim 8, in which the supporting projections (15a, 15b) are approximately triangular in section parallel to the plates (1, 2).

10. The discharge lamp as claimed in claim 1, in which the supporting elements (5, 15, 25, 35, 45, 55) delimit individual discharge locations (7), which, as a result of the delimitation, are narrower on the cathode side than on the anode side transversely with respect to the discharge direction.

11. The discharge lamp as claimed in claim 1, in which the set of electrodes (6) contains a number of strip-shaped electrodes, and individual discharge locations (7), which are arranged adjacent to the same electrode strip on the same side of the electrode strip, are each separated by a supporting element (5, 15, 25, 35, 45, 55).

12. A display device with a discharge lamp as claimed in claim 1, which is used for backlighting the display device.

13. A luminaire with a discharge lamp as claimed in claim 1.

14. The discharge lamp as claimed in claim 2, in which the supporting projection (5a, 15a . . . ) on the cover plate side consists substantially from a transparent material.

15. The discharge lamp as claimed in claim 2, in which the supporting projection (5a, 15a . . . ) on the cover plate side, towards the discharge space (4), has an outer face, which extends from the cover plate (1) as far as the supporting projection (5b, 15b . . . ) on the bottom plate side at least substantially continuously in such a way that it faces the bottom plate (2).

16. The discharge lamp as claimed in claim 2, in which the supporting projections (35a-55b) run in the form of ribs along the plates (1, 2).

17. The discharge lamp as claimed in claim 2, in which the supporting projections (5a-25b) have substantially the form of cones, pyramids, truncated cones or truncated pyramids with the respective base faces which face the plates.

18. The discharge lamp as claimed in claim 2, in which the supporting elements (5, 15, 25, 35, 45, 55) delimit individual discharge locations (7), which, as a result of the delimitation, are narrower on the cathode side than on the anode side transversely with respect to the discharge direction.

19. The discharge lamp as claimed in claim 2, in which the set of electrodes (6) contains a number of strip-shaped electrodes, and individual discharge locations (7), which are arranged adjacent to the same electrode strip on the same side of the electrode strip, are each separated by a supporting element (5, 15, 25, 35, 45, 55).
